(19) United States
(12) Patent Application Publication
(10) Pub. No.: US 2003/0179127 A1
(43) Pub. Date: Sep. 25, 2003

(54) People counter

(76) Inventor: Hans-Theo Wienand, K?ouml;ln (DE)

Correspondence Address: GREENBLUM & BERNSTEIN, P.L.C., 1950 ROLAND CLARKE PLACE, RESTON, VA, 20191, US

(21) Appl. No.: 10/333,736

(22) PCT Filed: Jul. 30, 2001
(86) PCT No.: PCT/EP01/08806

(30) Foreign Application Priority Data
Jul. 28, 2000 (DE) 100 37 099.3

(51) Int. Cl. G01S 7/40; G01S 13/58

(52) U.S. Cl. 342/28; 342/61; 342/114; 340/554; 340/572.1

(57) ABSTRACT

The invention relates to a device for counting at least one person (7) that passes a passage having a floor. Said device comprises at least one distance sensor (3, 4) that emits a cone or rays (5, 6) from radar rays or ultrasonic waves, receives the reflected rays/waves and provides an evaluation device with the received signals. Said cone(s) of radiation (5, 6) cover(s) the entire width of the passage and is/are disposed at an angle with respect to the direction of movement of the person (7) passing the passage. The aim of the invention is to improve people counters known from the art where the distance sensors are often disposed above head height and to provide a counter which is simple in design and which can be disposed as inconspicuously as possible and without being noticed by the people passing the passage. To this end, the distance sensor (3, 4) is accommodated in a housing (1, 2) disposed on the floor.

The invention relates to a device for counting people who pass through a passage with a floor, with at least one distance sensor that emits radar or ultrasonic rays in the form of a cone of rays, which receives rays reflected from a person and feeds the received signals to an evaluation device, whereby the cone(s) of rays covers/cover the entire width of the passage and are directed at an angle to the movement direction of the people passing through the passage.

People counters are known in different embodiments. Light barriers, foot mats, door contacts or turnstiles are most frequently used for this purpose. These devices serve the specified purpose only imperfectly. Light barriers have a large error rate, because they cannot distinguish between people, animals and objects. Foot mats and door contacts are also very unreliable, because they cannot distinguish the movement direction of the people to be counted. These devices are unusable in the case of wider passages. Turnstiles are considered obstacles.

In public buildings, such as town halls, schools, theatres, banquet halls, museums, in sports stadiums, department stores and the like, as well as on means of transportation, such as ships, aircraft and the like, the reliable counting of people is very important for statistical and safety reasons. Moreover, the heating, the ventilation and/or the air conditioning can be controlled, or overcrowding can be avoided for safety reasons, with the aid of the number of people ascertained. For a precise counting result, counting devices with distance sensors are used which work according to the radar principle, whereby the distance sensors feature an antenna that preferably emits electromagnetic waves, e.g., microwaves or infrared light. The signal reflected by a person or an object is received by the same or by other antennas and sent to the evaluation device. The evaluation device analyses the signal and determines the distance by means of the run time between transmitting and receiving a signal. Movement direction and speed of the measured object can also be determined by means of the change in the distance that results in a change in the intensity of the received signal, or by means of a frequency shift due to the Doppler effect. As a rule, the distance sensor is arranged above the heads of people passing through the passage with such counter systems. Examples of this are the documents U.S. Pat. No. 4,111,419, DE-A-33 01 763, U.S. Pat. No. 4,528,679, U.S. Pat. No. 5,138,638, U.S. Pat. No. 5,187,688. In the above-mentioned documents, to count the people passing through a passage as a rule the sensors are mounted exactly above the passage, whereby the cones of rays run downwards in a perpendicular manner.

The applicant's European patent application EP-0 718 806 A2 discloses such a device, in which the cones of rays are oriented at an angle to the movement direction at an angle of 20 to 25° to the perpendicular. By means of this angled position each individual sensor can determine the movement direction by the change in distance when a person moves through the passage, so that information can be obtained from the evaluation device on whether a person is moving through the passage into a monitored area or out of this area.

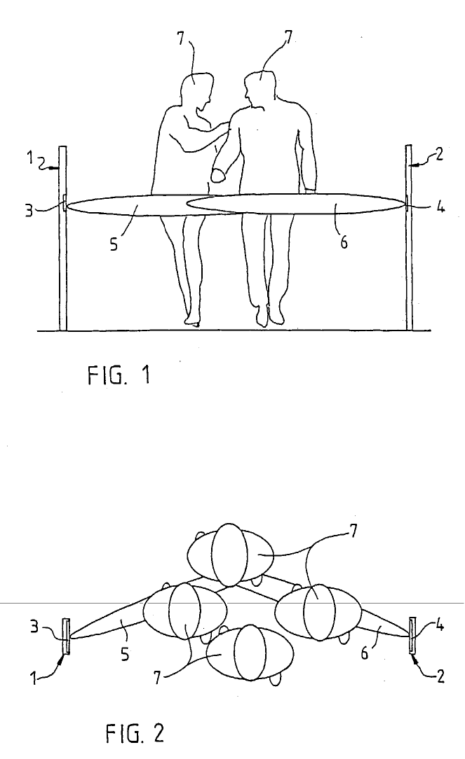

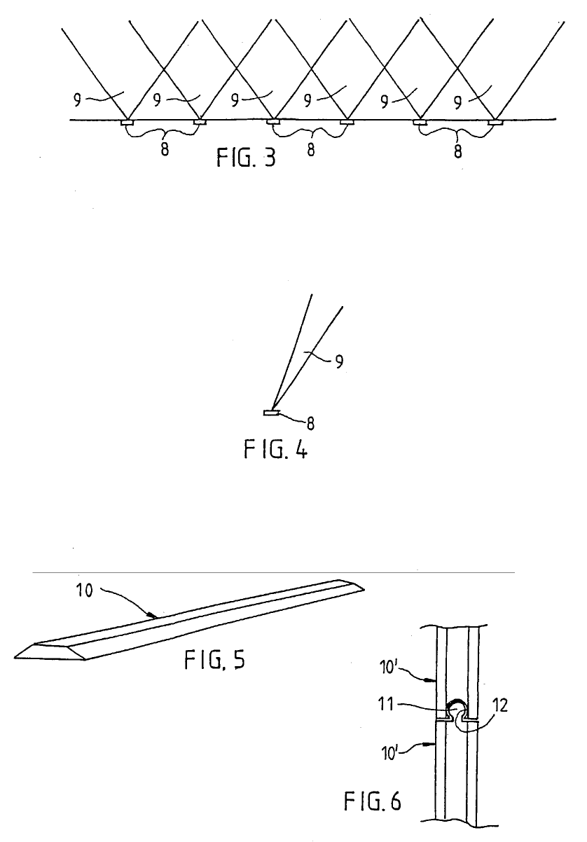

A similar device is disclosed by document U.S. Pat. No. 3,997,866. Here either the sensor is arranged overhead (FIG. 1) or a sensor embodied as an antenna with funnel is attached to a riser (FIG. 3) at a vehicle entrance. In particular the sensor attached in the step area and forming a projection is easily noticed by people entering the vehicle. A kick to this sensor can damage or destroy it.

The object of the invention is to further develop a people counter such that it is simple in design and can be arranged as inconspicuously as possible and unnoticed by people going through the passage.

This object is attained according to the invention in that at least one distance sensor is arranged in a preferably flat housing arranged on the floor.

Attaining this object is rendered possible in particular by the use of a directional antenna for microwave rays, which antenna forms the distance sensor. A particularly flat sensor is constructed, making it possible to insert it into a housing of only 10 mm thickness, according to the principle of a patch array antenna, which features a plurality of centrally supplied individual antennae, so-called Patch resonators, on a flat carrier plate. An angled position of the field of radiation of the antenna, called a cone of rays here, is obtained by supplying the various patch resonators with signals of different amplitude and different phase position. The construction of patch array antennas with asymmetrical directional characteristic is known, e.g., from the communications technology and described in the book Broadband Patch Antennasby Zürcher et al., ISBN 0-89006-777-5, pp 152 through 159. The Patch resonators are applied to a printed circuit, so that the antenna itself has a construction height of only a few millimeters.

The width of the housing can be well under 100 mm. A construction for practical use features a width, i.e., an extension in the longitudinal direction of the passage, of 70 mm. The width of the housing to accommodate the new patch array antenna can be under 50 mm.

However, it is also possible to use level patch antennas with symmetrical directional characteristic, i.e., with a field of radiation running symmetrically to the plane normal on the carrier plate of the antenna, which are tilted to obtain the angled position of the cone of rays. With customary construction sizes of the patch array antennas used here with a range for distance measurement of less than 5 meters, mostly 1 to 2 meters, the length of the printed circuit bearing the Patch resonators is approx. 70 mm. With a tilt of the antenna of about 10° to its cross axis, the distance between the planes in which the front and the rear cross edge of the antennas lie is less than 12.5 mm. It is thus possible to install even tilted patch array antennas with symmetrical directional characteristic in level housings that have a thickness of less than 20 mm.

The integration of the distance sensor for the people counter according to the invention into such a flat and small housing makes it possible to integrate the sensor into already existing structures without it being visible from the outside. In monitoring department stores, for instance, the integration of the sensor into the antennas of an anti-theft system attached to the floor presents itself. As a rule anti-theft systems detect signals from passive data storage media that are installed to prevent theft of the goods displayed for sale in the department store. Such data storage media are firmly attached, but such that they can be removed by the sales staff. Magnetic strips, which can be detected by the antennas of the anti-theft systems, are also attached to the goods. In modern department stores a plastic housing is therefore usually mounted on one or more bars on both sides of a passage, in which housing the antennas of anti-theft systems are installed. When people with secured goods pass through these stock protection antennas, an alarm signal sounds.

Due to the limited range of the antennas of stock protection systems, the usual widths of the passages between two stock protection antennas is approx. 1 to 2.5 m. This passage width is optimally suited for the use of the described patch array antennas, which likewise have a restricted range due to their construction and the relatively weak electromagnetic signals.

The flat housings of the stock protection systems which feature surfaces extending in the longitudinal direction of the passage, i.e., parallel to the movement of passing persons, can also contain the distance sensors of the people counters according to the invention. The sensors are not visible to the people passing through. Furthermore, installing the sensors in these housings is much simpler than installing them above the passage, which as a rule is associated with special constructional measures and with the installation of additional power cables and signal cables. In jointly using the housing of the anti-theft antennas, the necessary power supply is already available as a rule. Data and signal cables of the anti-theft system can either be jointly used or, because the sensors for the people counter are close to the ground, they can be laid anew at little expense.

The device according to the invention with distance sensors, in particular radar sensors, has essential advantages compared with light barriers, which are already often used today for counting people in combination with anti-theft systems. For one thing, as a rule the movement direction of a person passing through cannot be detected by the light barrier. To this end a second light barrier would have to be installed just behind a first light barrier. For another thing, the counting process is disrupted if a person stops in the passage. By using the distance sensors according to the invention on both sides of the passage, the operability of the second sensor is still available if the first sensor is covered by a person standing still. Because of the angled position of the cone of rays of the sensors to the movement direction, it is possible to detect the movement direction of a person by evaluating the signal of a single distance sensor of the device according to the invention.

The cones of rays of both sensors extend essentially in a symmetrical manner to a vertical plane from the edge of the passage towards its center. The angled position of each cone of rays to the crosswise direction of the passage is thereby preferably 10 to 20°.

As mentioned, the width of the passage between the two housings of the anti-theft systems should be in the range of 1 to 2.5 m. Of course, in order to obtain a wider entrance or exit, several such passages can be arranged next to one another, each of which has its own stock protection system and thus also two distance sensors of the people counter system according to the invention arranged laterally in the housings of the stock protection antennas. All the distance sensors of the passages next to one another are connected by data or signal cables to the same evaluation device, which evaluates the signals from the sensors and determines the number of people passing through the passage. In particular the signals of the sensors arranged on opposite sides of a passage, the cones of rays of which are directed towards one another and towards the middle of the passage, are compared by the evaluation device, in order to avoid counting twice one person who generates a sensor signal on both lateral sensors. All the distance sensors of a monitored building or a monitored, closed area are preferably connected to the same evaluation device, which determines the total number of people located within the building or area by analyzing all the signals. A conventional personal computer is suitable for signal evaluation, whereby analog to digital converters convert the signals of the distance sensors (patch array antennas) into digital signals, which are evaluated on the computer by an evaluation software. Since modern personal computers are extremely powerful, the personal computer used as an evaluation device can also be used at the same time for other functions in building monitoring and protection, e.g., for digital storage of image sequences from surveillance cameras, to control and monitor the anti-theft system. In department stores the computer can continue to be used for general data communication (controlling the individual register terminals of a central register computer, etc.).

Alternatively to the lateral arrangement of the sensor housing, the flat housing can be installed on the floor, whereby the cone of rays essentially extends upwards. Since the housing is preferably less than 10 mm high, angled surfaces that run in the crosswise direction of the passage and form an angled transition to the plane of the floor can be sufficient to avoid the risk of people going through the passage stumbling over the housing running crosswise. Alternatively, a recess extending crosswise can be provided in the passage, in which recess the housing is inserted so that its surface is flush with the plane of the floor.

The distance sensors emitting rays upwards detect a signal as soon as a person steps over them. A very reliable detection of the people passing through the passage can be obtained by digital signal processing and the comparison of the signals that are produced by the people going through the passage, with signals that are produced, e.g., by animals or shopping carts. The cone of rays is again angled in the movement direction, i.e., it features an angle of preferably 10 to 20° to the vertical plane running in crosswise direction of the passage.

Such a device can be installed at any location without great expense, e.g., in the entrance areas of sports stadiums, concert halls or open-air event sites. Several distance sensors are preferably arranged in longitudinal flat housings that extend over a certain width, e.g., 1 or 2 m.

For monitoring particularly wide passages, the flat housings can feature connecting elements at their ends, which elements can be joined together in a form-locking manner. Thus several flat housings each with several measurement sensors can be arranged next to one another and firmly connected in order to monitor the entire width of a passage.

Plastic is particularly suitable for the manufacture of the flat housing, since when radar beams are used it does not interfere with their reception.

As already mentioned, patch array antennas are preferably used as distance sensors. These antennas can either be provided with transmission antenna elements and reception antenna elements or when transmitting the radar signal simultaneously receive a superimposed receiving signal, which is separated from the transmission signal by a suitable electrical circuit.

The frequency range that is usually kept free for such applications is at 24,125 GHz, i.e., in the microwave range. The antennas should be configured for this frequency band.

It is expressly pointed out that the invention also comprises a combination of at least one housing arranged on one side of the passage and one housing installed on the floor, both of which each feature at least one distance sensor, in particular a patch array antenna, described above.

Alternatively to the above-mentioned exemplary embodiments or in addition to at least one of the above-mentioned exemplary embodiments, it is also provided according to the invention to arrange the housing with at least one distance sensor in a ceiling of the passage, i.e., above the heads of the people passing through the passage. This housing and the at least one distance sensor preferably feature at least one of the technical features described above.

Preferred exemplary embodiments of the invention are described below with reference to the attached drawings. The drawings show:

FIG. 1 A front view of a passage with a first embodiment of the counter sensor according to the invention, and

FIG. 2 A plan view of the passage from FIG. 1

FIG. 3 A front view of a second embodiment of the counter device according to the invention, and

FIG. 4. A side view of the counter device from FIG. 3,

FIG. 5 A diagrammatic representation of a housing for a distance sensor of the counter device from FIGS. 3 and 4,

FIG. 6 A plan view of a variant of the housing from FIG. 5 with form-locking connection elements at the ends,

FIG. 7 A plan view of a patch array antenna which is used as a distance sensor with the device according to the invention,

FIG. 8 A front view of the antenna from FIG. 7 and

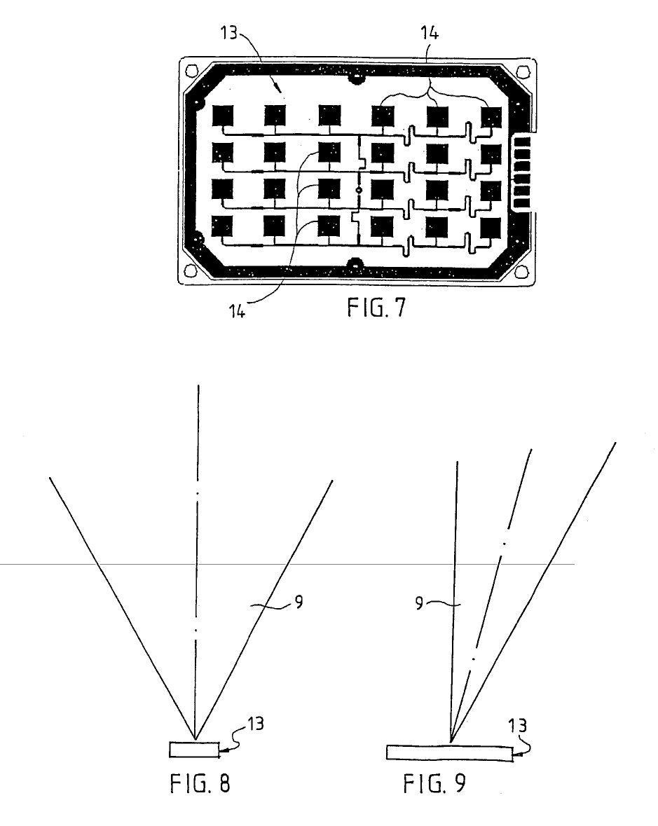

FIG. 9 A side view of the antenna from FIG. 7.

A customary passage for a department store is shown in FIGS. 1 and 2, at the sides of which two flat antenna housings 1 and 2 made of plastic are located for containing the antennas of the stock security or anti-theft systems (not shown). The distance sensors 3 and 4 of the people counter according to the invention are arranged at about hip height. They are made of new patch array antennas described below. Their cone of rays 5, 6 extends essentially symmetrically to a horizontal plane. The cone of rays 5, 6 of each sensor 3, 4 is thereby tilted by about 20° (see FIG. 2) to the crosswise direction of the passage that runs between the two antenna housings 1, 2.

As soon as a person 7 steps through the passage, the high-frequency, electromagnetic waves emitted by the distance sensors 3, 4 are reflected and the reflected signals are received by the distance sensors 3, 4 and fed to the evaluation device (not shown). The evaluation device determines from the intensity of the reflected signals the distance of the passing persons 7 from the respective distance sensor 3 or 4. Since the cones of rays 5, 6 run at an angle to the movement direction of the persons 7, a continuously increasing or decreasing distance value results, depending on the movement direction. Each individual sensor 3, 4 is thus suitable for detecting the movement direction of the passing person. On the basis of the measured distance value it can be ascertained whether two people are passing through the passage next to one another or both distance sensors 3, 4 are detecting the signal of an individual person 7 passing through the passage.

The signal evaluation is preferably made by means of a central computer, whereby interference signals can be effectively identified and filtered out and a reliable counting of people passing through the passage can be made, if necessary, with a statistical evaluation of people movements during a specific period. The distance sensors 3, 4 at various passages can be connected to a central evaluation device.

The ranges of both sensors 3, 4 arranged at the side of the passage have to overlap one another, so that a complete monitoring of the entire passage is ensured.

FIGS. 3 and 4 show another embodiment of the people counter according to the invention. Here the distance sensors 8 are not arranged at the side of the passage, but on its floor in crosswise direction of the passage. The cones of rays 9 of the distance sensors 8 are thereby tilted at an angle of about 10° to the running direction (cf. FIG. 4), i.e., they run symmetrically to a plane that is tilted at an angle of 10° to the vertical plane running in crosswise direction of the passage.

Several distance sensors 8 are arranged across the width of the passage at regular intervals of approx. 10 to 50 cm, the cones of rays 9 of which sensors overlap, so that passing people are reliably detected in every area of the passage.

FIG. 5 shows an embodiment of a housing 9 for the distance sensors 8 according to the invention, which housing is installed in the floor. The housing 10 has an essentially trapezoid cross section, whereby the sloping surfaces feature a slight incline to the surfaces parallel to one another. The height of the housing 10 is about 10 mm, so that the housing 10 with the slightly tilted angled surfaces does not form an obstacle to people passing through the passage.

FIG. 6 shows the ends of two alternative housing 10′. The housing 10′ features at one end a projection 11 and at the other end a recess 12, which can be inserted into one another in a form-locking manner. Several housings 10′ can thus be arranged next to one another and connected to one another, if a passage of greater width is to be monitored.

Of course, the distance sensors have to be connected by cable in the housings 10′, whereby a connecting cable for the power supply and signal transmission extends outside. The cables can be provided with plugs and couplings so that the connections of several housings 10′ connected by means of projection 11 and recess 12 can be connected to one another and then jointly connected to the evaluation device.

FIG. 7 shows a new kind of patch array antenna 13 that is preferably used as a distance sensor with the device according to the invention.

The Patch resonators 14 of the patch array antenna 13 are arranged in a matrix of four rows and six columns. The resonators 14 in each column are supplied with a signal of the same intensity and phase position. In the rows a signal of different amplitude and phase position is fed to each of the patch resonators. The result is that the cone of rays of the antenna in the direction of the extension of the columns with four Patch resonators 14 each, i.e., in the short crosswise direction of the patch array antenna 13, features a symmetrical cone of rays 9 (cf. FIG. 8). The cone of rays has a large opening angle in order to cover the largest possible width of the passage with the embodiment from FIGS. 3 through 6. In the direction of the rows, i.e., in the direction of the long edges of the patch array antenna 13, the cone of rays 9 is asymmetrical, i.e., it runs at an angle to the plane of the surface normal on the surface of the patch array antenna 13.

### List of Reference Numbers

1 Antenna housing

2 Antenna housing

3 Distance sensor

4 Distance sensor

5 Cone of rays

6 Cone of rays

7 Person

8 Distance sensor

9 Cone of rays

10 Housing

10′ Housing

11 Projection

12 Recess

13 Patch array antenna

14 Patch resonator

1. Device for counting at least one person (7) who passes through a passage with a floor, with at least one distance sensor (3, 4; 8), which emits radar or ultrasonic rays in the form of a cone of rays (5, 6; 9), which receives the rays reflected by the at least one person, and feeds the received signals to an evaluation device, whereby the cone(s) of rays (5, 6; 9) covers/cover the entire width of the passage and are directed at an angle to the movement direction of the person (7) passing through the passage, characterized in that the distance sensor (3, 4; 8) is arranged in a flat housing (1, 2; 10, 10′) arranged on the floor.

2. Device according to claim 1, characterized in that the device features several distance sensors (3, 4; 8), each of which emits a cone of rays (5, 6; 9) of radar or ultrasonic rays, which receive the beams reflected by the at least one person and feed the received signals to an evaluation device, whereby the cones of rays (5, 6; 9) cover the entire width of the passage and are directed at an angle to the movement direction of the person (7) passing through the passage, and that a single distance sensor (3, 4; 8) or several distance sensors is/are arranged in the housing.

3. Device according to claim 1 or 2, characterized in that the housing (1, 2; 10; 10′) is attached to the floor.

4. Device according to at least one of the preceding claims, characterized in that the flat housing (1, 2; 10, 10′) is less than 50 mm thick, preferably approx. 10 mm.

5. Device according to at least one of the preceding claims, characterized in that a flat housing (1, 2) is respectively arranged on both sides of the passage, which housing features in addition to a distance sensor (3, 4) a detection sensor of an anti-theft system.

6. Device according to claim 5, characterized in that both flat housings (1, 2) feature surfaces facing one another and extending in the longitudinal direction of the passage.

7. Device according to claim 5 or 6, characterized in that the cones of rays (5, 6) of the distance sensors (3, 4) are directed essentially horizontally and at an angle of more than 5°, preferably 10° to 20°, to the crosswise direction of the passage.

8. Device according to at least one of claims 5 through 7, characterized in that the width of the passage between the two flat housings (1, 2) is less than 5 m, preferably 1 to 2.5 m.

9. Device according to at least one of the preceding claims, characterized in that the flat housing 10 is placed on the floor.

10. Device according to claim 9, characterized in that the flat housing (10) is inserted in a recess in the floor extending in the crosswise direction of the passage.

11. Device according to claim 9 or 10, characterized in that the cone(s) of rays (9) are tilted at an angle of more than 5°, preferably 10° to 20°, to a vertical plane running in the crosswise direction of the passage.

12. Device according to at least one of claims 9 through 11, characterized in that the flat housing (10) is embodied in an oblong manner and features several distance sensors at intervals.

13. Device according to at least one of claims 9 through 12, characterized in that several flat housings (10′) are arranged next to one another across the entire width of the passage, whereby each end section of a flat housing (10′) features a connecting element (11, 12) which interacts with an end section of an adjacent flat housing (10′) in a form-locking manner.

14. Device according to at least one of the preceding claims, characterized in that the flat housing (1, 2; 10 10′) is made of plastic.

15. Device according to at least one of the preceding claims, characterized in that each distance sensor (3, 4; 8) is formed by a flat patch array antenna (13) for transmitting and receiving electromagnetic waves.

16. Device according to claim 15, characterized in that the patch array antenna (13) features several Patch resonators (14), which are arranged in rows running in the longitudinal direction of the passage, whereby the successive Patch resonators (14) in a row are supplied with signals of different amplitudes and phase positions.

17. Device according to claim 15 or 16, characterized in that the patch array antenna (13) emits electromagnetic radar beams in the frequency band of approx. 24 GHz.
